(19) United States
(12) Patent Application Publication
(10) Pub. No.: US 2015/0359212 A1
(43) Pub. Date: Dec. 17, 2015

(54) Scented Footwear System for Hunting

(71) Applicant: James A. Bulger, Bainbridge, GA (US)

(72) Inventor: James A. Bulger, Bainbridge, GA (US)

(21) Appl. No.: 14/742,476

(22) Filed: Jun. 17, 2015

Related U.S. Application Data
(60) Provisional application No. 62/012,991, filed on Jun. 17, 2014.
(60) Provisional application No. 62/159,184, filed on May 8, 2015.

(51) Int. Cl. A01M 31/00; A43C 19/00

(52) U.S. Cl. CPC A01M 31/00; A43C 19/00

(57) ABSTRACT

A combination of a footwear sole or an over sole with a scented pad in which the scented pad is received on the bottom of the sole. The scented pad is retained by clip devices that are integrated into the sole during manufacture or added to a footwear sole or over sole. The scented pad is removable from the clip devices for replacement after use. The scented pad may receive scented chemical from a bottle that is attached to a receiver cap attached to the heel of the sole. The chemical transfers through a tube that is connected to a pump for dispersal of chemical from the tube onto the scented pad while a hunter is walking.

### PRIORITY CLAIM

The present application claims benefit of priority of U.S. provisional patent application No. 62/012,991 to James A. Bulger filed on Jun. 17, 2014 and also claims benefit of priority of U.S. provisional patent application No. 62/159,184 to James A. Bulger filed on May 8, 2015.

### FIELD OF THE INVENTION

This invention relates to scent distribution for hunting wild game, and more particularly to footwear adapted for distribution of a game attracting scent.

### BACKGROUND OF THE INVENTION

It is widely known that wild game and other animals have a keenly acute sense of smell, especially for odors that naturally attract them within their natural habitat. Hunters will often use scented attractants to mask the odors that may emanate from humans while attempting to position themselves in close proximity to the game. Hunters and other outdoor enthusiasts have resorted to spraying naturally occurring aromatic scents, such as deer lure, on their clothing in an attempt to mask their own odors.

The feet are an especially vulnerable area for humans since the feet tend to be enveloped in protective layers of footwear, such as socks, shoes, boots, etc. In this environment, the feet may perspire and emanate strong odors that are sometimes even perceptible to humans. Foot perspiration and odor can be absorbed by footwear and transferred to the ground as the person walks, resulting in a human scent trail that is easily recognizable by animals. Portions of the footwear such as the sole or upper, are typically constructed of leather, porous plastics, fibrous material, etc. These types of materials are especially subject to the absorption and transfer of odors emanating from the feet.

In an attempt to prevent a human scent trail while walking or hiking, it is common to wear rubber boots in place of hiking or hunting boots. U.S. Pat. No. 5,024,008 issued to Maples improves the comfort of the hiking footwear and decreases the transfer of human scent by providing a rubber overshoe that fits over the sole of a hunting boot to thereby prevent mutual contact between the boot and ground. In Maples, a scent dispenser in the form of an inserted dispenser is attached to the overshoe for dispensing scent to the ground as a hunter walks. U.S. Pat. No. 4,722,477 to Floyd provided for a scent distribution device to be attached the foot or leg of a hunter and distributes scent through exposure to the air.

### SUMMARY OF THE INVENTION

A scented footwear system is provided that overcomes several of the limitations of Maples, Floyd and others by provided a robust distribution of scent from footwear, such as hunting boots or shoes. An object of the invention is to provide a scented pad that attaches to a clip provided on a footwear sole. The scented pad cooperates with a cavity in the bottom of the footwear's sole or simply the bottom surface of a footwear's outsole to distribute a scent to the ground. Another object is to integrate the clip for the scent pad into the sides of a footwear's sole for attachment of a scent pad. In an embodiment of the invention, clips for holding a scented pad are manufactured into the sole and extend outward from the sides of the sole for retention of the tips of the scented pad. Another object is to provide a removable footwear covering outsole with clips for a scent pad. Another object is to provide a footwear sole with removable clips that can be replaced and that function to hold a scent pad onto the sole of footwear, such as a boot or shoe. Another object is to provide an optional mount for a container of scent to be distributed to the scented pad. Yet, another object is to distribute scented chemical from the scented pad during hunting to provide constant and robust distribution of scent without diminution of quality. Still another object is to provide a means to pump scented chemical from a reservoir to a scented pad via a system that works in combination with an over sole for hunters.

### BRIEF DESCRIPTION OF THE DRAWINGS

FIG. 1 is a perspective assembly view showing components of the scented footwear system of the present invention in an exemplary over sole embodiment.

FIG. 2 is a partial plan view of the overshoe embodiment of FIG. 1 illustrating the retention clip and scent pad in combination with an over sole.

FIG. 3 is a partial assembly view of the clip and holder in accordance with an embodiment of the invention.

FIG. 4 is an enlarged partial plan view of a clip and holder with a scent pad attached thereto in accordance with an embodiment of the invention.

FIG. 5 is a bottom plan view of a shoe sole adapted with a scent pad in accordance with an embodiment of the invention.

FIG. 6 is a plan view of a rubberized over sole incorporating a reservoir of scent fluid in accordance with an embodiment of the invention.

FIG. 7 is a perspective view of an exemplary embodiment of the invention wherein a clip for retaining a scented pad is incorporated via integration with the sole of footwear.

### DETAILED DESCRIPTION OF THE INVENTION

The scented footwear system for hunting includes one of several embodiments that include a scented pad 10 with opposing ends, wherein the scented pad is retained by attaching the opposing ends to clip devices 11 extending from the opposing side edges of a footwear's sole. A centrally position padded portion of the scented pad 10 is situated beneath the outsole of the footwear after the scented pad is attached to the sole via the clip devices.

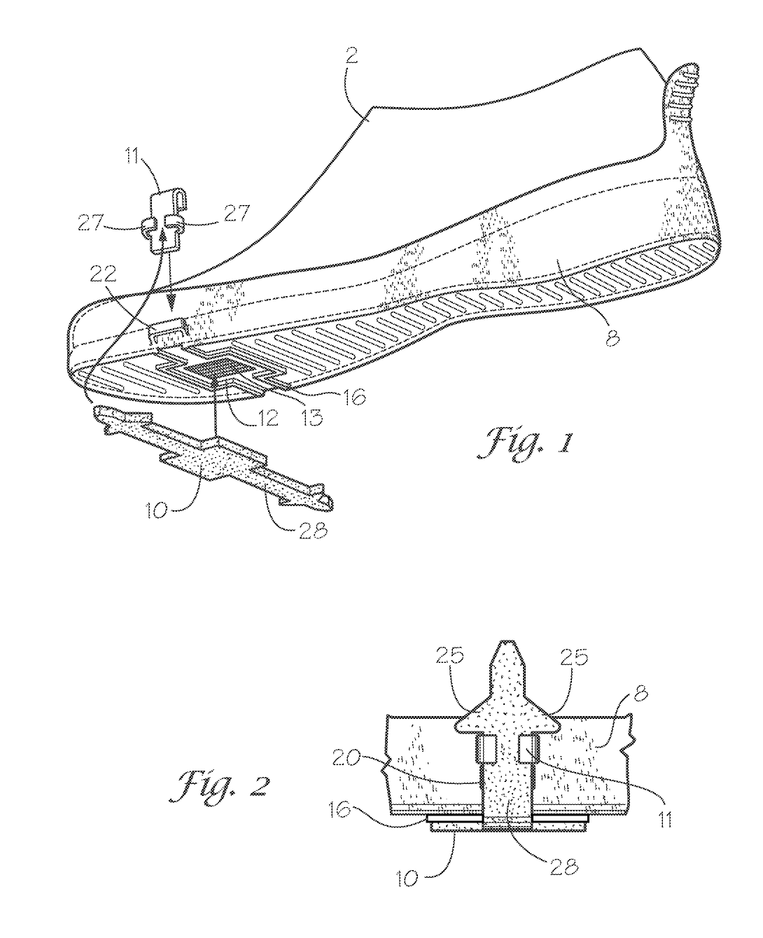

FIG. 1 illustrates a first embodiment of the scented footwear system that provides a rubberized over sole 8 for placement on an existing footwear 2. The thermal plastic over sole 8 may be installed on existing footwear by slipping a front tip of the over sole over the toe of the footwear consisting of a hunters boot or shoe. The over sole 8 is stretched backwards underneath the bottom of the boot or shoe and attaches to a heel of said boot or shoe. In the particular embodiment of FIG. 1, the bottom of the provided over sole 8 has a cavity 12 therein. A similar cavity may be constructed into a hunting boot or shoe during manufacture to provide a reservoir for a centrally padded portion of the scent pad that holds scented fluid. The cavity 12 is shaped to hold the scent pad 10, which may be fitted to a particular sized cavity. The fitted scent pad 10 is retained in the cavity for control and comfort of the hunter. Optionally, a hook and loop fastening material 13 as shown in FIG. 1 may be added to the scent pad and the cavity or bottom of the sole for added retention of the pad. However, the clip devices 11 described herein have been found sufficient in retaining the position of the scent pad 10. The scent pad absorbs liquid scents for the purpose of allowing hunters the opportunity to leave game-tracking scent each and every time they take a step. The thermal plastic molded scent pad cavity 12 on the bottom of the footwear 2 or over sole 8 is designed to keep scent flowing downward, towards the ground, instead of upward towards the bottom of the hunters boot or shoe. Solid forms of game attracting scent can also be placed into the over sole cavity 12 for the purpose of leaving game attracting scent with each step. Furthermore, the bottom of the over sole 8 includes a thermal plastic lug pattern on the bottom surface thereof, which helps maintain traction while laying down a scent trail to a deer hunting stand or like. However, the over sole 8 may not be designed to replace the bottom lug pattern on boots or shoes, which are designed for the purpose of obtaining traction in varied hunting terrains, wherein the over sole may be removed during treks through rugged terrain by a hunter.

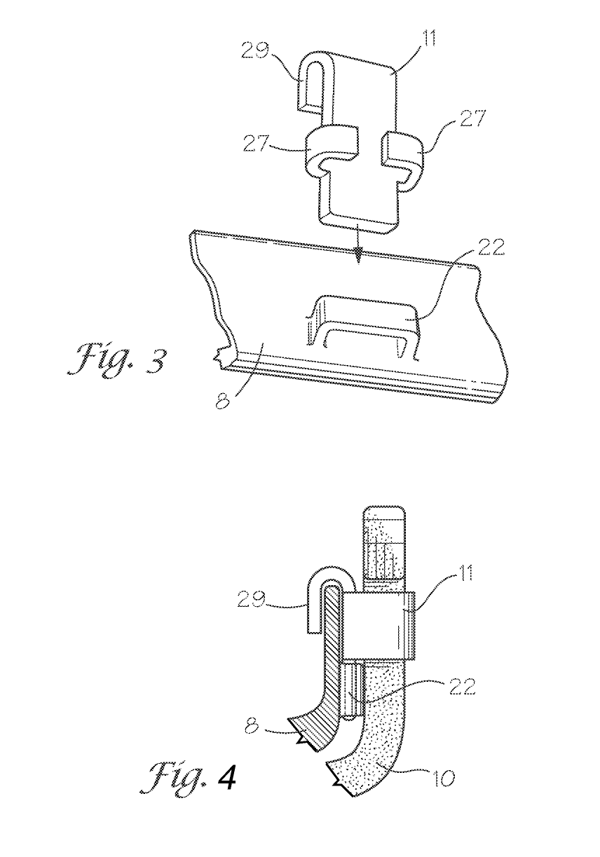

FIG. 2 illustrates a portion of the clip and sole combination in the particular embodiment shown therein. The sole includes a portion removed from the sole to form a retaining wall 16 for the strap 28 of the scent pad. The combination of a clip 11, cavity 12, and retaining wall 16 operated to control and maintain the position of the scent pad 10 during walking by the hunter. The clip 11 may be integrated into a sole 8 or added to the sole via a clip holder 20, shown in more detail in FIGS. 3-4. The sole may include a clip holder retaining bracket 22 that is attached to the sole for insertion and retention of the clip using an inserted flange or holding member 29. In the design of the clip 11 shown in FIG. 2, the clip provides opposing c-shaped appendages 27 on each side of the clip for insertion of the strap 28. The strap terminates on each end with a member of the strap of increased width having horizontal extensions 25 that extend beyond the edges of the clip appendages when the strap 28 is inserted. The strap extensions 25 rest above the top surface of the clip appendages to prevent downwardly pulling the strap out from the clips. Meanwhile, the strap itself is overlapped by the c-shaped appendages of each clip for retention of the strap to prevent lateral pulling of the strap from the clips.

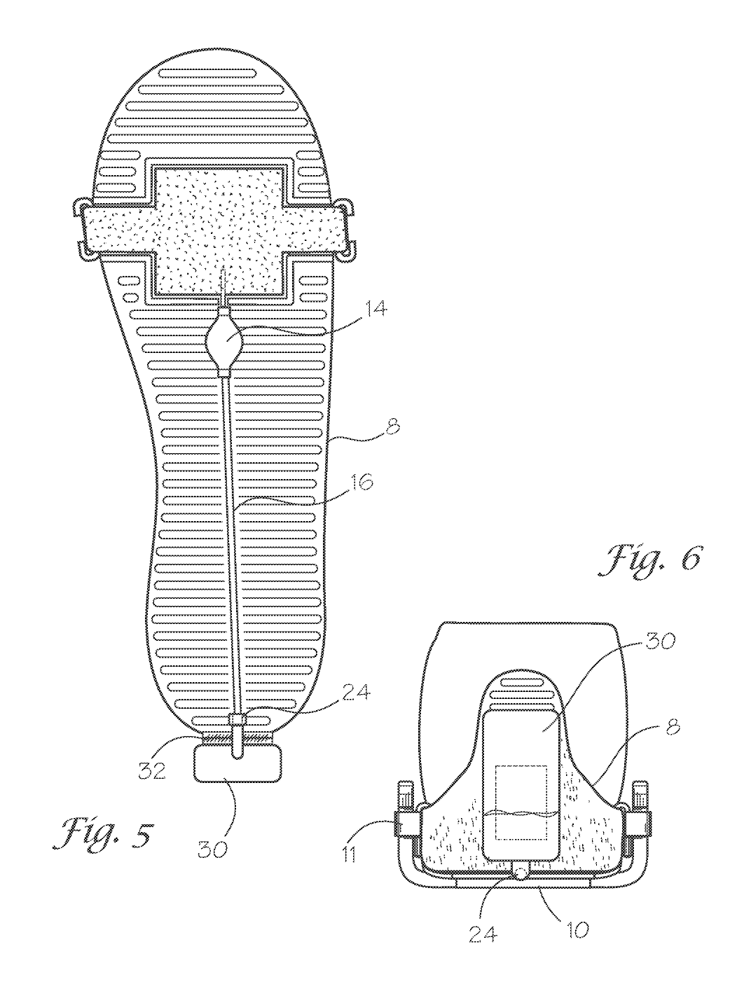

Furthermore, as shown in FIGS. 5-6, the scented footwear system with its over sole design can hold a bottle 30 with up to two ounces of game attracting scent that can be fed to the pad 10 via thermal plastic straps 28. The bottle reservoir may be built into the over sole 8. The straps 28 are incorporated onto the over sole 8 as previously shown in FIG. 1, and the reservoir of chemical may be incorporated into the over sole where the over sole attaches to the heel of the footwear, such as a boot or shoe. Strapping the bottle 30 vertically to the heel of a hunter's boot or shoe as shown in FIG. 5, keeps hunters from having to re-apply game tracking scent while walking to and from their deer hunting stands. The bottle 30 may be held in place by thermal plastic straps that position the bottle in an upside down vertical position, so liquid can flow out of the bottle, or the bottle may be retained by hook and loop fastening material 32 as shown in FIG. 5.

A threaded receiver cap may be permanently installed on the bottom of the over sole 8, which allows hunters the opportunity to attach a scent bottle 30 to the threaded receiver cap while the bottle is in the vertical position. Attached to the threaded receiver cap or the bottle 30 is a 90 degree threaded receiver port 24, which is used for attaching a ⅛-inch flow tube 16. This ⅛-inch flow tube 16 is built into the bottom of the over sole 8 via a recess in the treads of the over sole, and the flow tube runs from the heal of the over sole frontwards, where the tube may then be attached to a small ball valve pump 14 located just behind the scent pad cavity 12. A portion of the ball valve pump 14 extends below the surface of the bottom of the over sole 8. The ball valve is designed to collapse and pump a small amount of liquid scent into the scent pad 10 via a nozzle as the ball valve collapses from the walking motion of the hunter. Thus, the scent pad 10 located in the cavity 12 receives replenishment of scent chemical each and every time a hunter steps and puts pressure on the bottom of the over sole 8.

The uniquely designed scented footwear system scent pad cavity 12 located on the bottom of the over sole 8 or specially manufactured footwear includes at least two advantages. The first is to allow hunters the opportunity to pour game tracking scent into the pad 10, then manually attach the pad to the over sole 8. Alternatively, the hunter can install a game attracting scent bottle 30 into a threaded receiver port 24 on the back heal of the over sole 8 and pump scent into the scent pad 10 within the cavity with each step taken.

A second advantage of the scented footwear system scent pad 10 is that the scent pad can be removed from the over sole 8 and then used as a manual scent dispersal pad. For example, the scent pad may be removed from the over sole cavity 12, and then hung approximately 5-foot off the ground near a hunting stand location, for wind-scent dispersal.

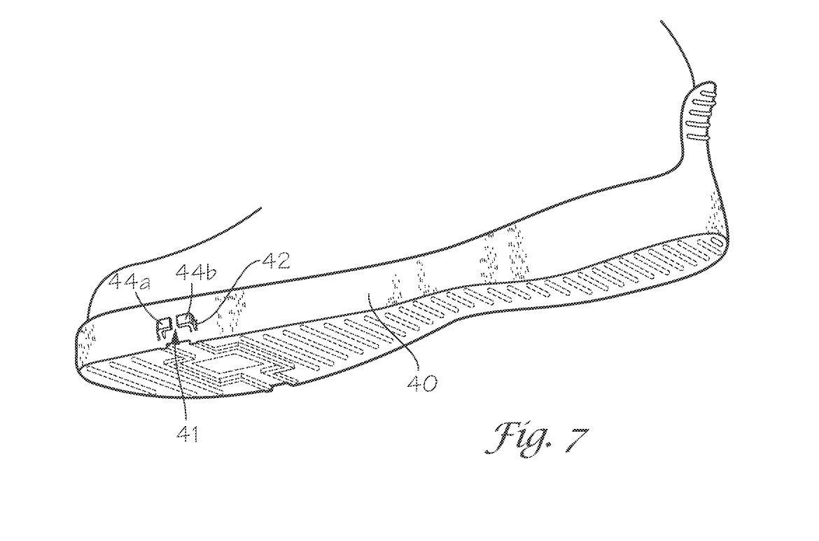

FIG. 7 illustrates an embodiment of the scented footwear system in which clip devices 41 are integrally formed and built into footwear 40 at the manufacturing level. Alternatively, the clip devices may be attached as a part of the construction process of the sole of the footwear. And, additionally, the clip devices may be permanently installed onto or into the sole post-manufacture of the footwear. In this regard, the clip device may be integrated into the sole of the footwear in any desirable way to form the clip devices for holding a scent pad 10. Some examples include but are not limited to molding the clip devices along with the sole during manufacture, permanently gluing, welding or adhering the clip devices onto the side edges of the sole, or attaching a portion of the body of the clip devices within the inner body of the sole, wherein a portion of the clip devices is covered by the rubberized material of the sole. The clip devices shown in FIGS. 1-7 provide an embodiment of clips designed for insertion of tabbed ends of the scent pad, wherein the tabbed ends include extensions 25. The clips include opposing fingers or c-shaped appendages. The opposing fingers include first members 42 that extend outward perpendicular to the side edge of the footwear sole. The opposing fingers include second members 44a and 44b that oppose one another and that fold the opposing fingers inward horizontally toward neck portions of the strap of the scent pad. Thereby, the second members of the opposing fingers overlap and retain the neck members of the strap once the scent pad 10 is inserted into the clips 41.

With regard to the embodiment of the scent pad shown, the neck portions of the strap 28 of the scent pad oppose and extend from the centrally positioned padded portion of the scent pad and terminate in a set of tabbed portions 25 of the scent pad on opposing ends of the pad. As discussed above, the neck portions insert into a gap between the second members 44a and 44b of the opposing fingers for retaining the scented pad. In addition, the tabbed portions are wider than the clips' bodies, whereby the tabbed portions of the scent pad rest on top of the clip body of each clip. The tabbed portions of the scent pad further assist to retain the scent pad with the clips.

The present scented footwear system provide a method that gives a consumer the option of hunting with or without a scent pad. In one embodiment, the consumer with a traditional pair of hunting boots may incorporate the scented footwear system using an over sole incorporating the features and advantages of this invention. In another method of the embodiment, the consumer may purchase hunting boots in which clip devices and a cavity have been incorporated into the sole of the footwear, whereby the consumer does not need the additional over sole to use the scented footwear system. Rather, the consumer may use the integrated clip devices to attach a scent pad and position the centrally padded portion on the bottom of the footwear. Or, the consumer may choose not to use a scent pad during a particular hunt, despite the utility of the footwear with the present system providing that option. Such choice is an advantage of the invention that provides flexibility and lower costs for bow Hunters, early season gun hunters, and others who may not use scent at the first of a deer season or such. However, as a seasonal rut approaches, hunters often desire to use drag rags or scent bombs that are no longer required because of the advantages herein. By purchasing boots with integrated clip devices as discussed herein, the hunter may purchase only the needed scent pads according to the method of this invention and attach the scent pads to boots only when desired.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

I claim:

1. A scented footwear system for hunting comprising
a. opposing clips attached on each side of a sole of a footwear;
b. a scent pad for disposition on a bottom surface of the sole;
c. said scent pad including opposing straps; and
d. said straps each including tabbed portions on the terminal ends of the straps, whereby the straps insert into the opposing clips and the tapped portions hold the straps of scented pad onto the footwear.
